(19) United States
(12) Patent Application Publication
(10) Pub. No.: US 2010/0259043 A1
(43) Pub. Date: Oct. 14, 2010

(54) System and Method for Harnessing and Distributing Normally Wasted Human Energy

(76) Inventor: Joseph S. Balsamo, Lake Forest, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/422,286

(22) Filed: Apr. 12, 2009

(51) Int. Cl. F03G 5/00; H02J 1/12

(52) U.S. Cl. 290/7; 307/25

(57) ABSTRACT

To harness the power generated by the fitness machines as a result of work expanded by human operators, the health equipment facility includes an On-Site Energy Generation, Storage and Distribution (GSD) module that serves as a medium between the local facility power distribution system and an external power grid. In general, the GSD module includes hardware, firmware and/or software for converting the mechanical energy generated by one or more fitness machines to electrical power, as well as computer executable instructions for allocating the electrical power between the local distribution system and an external power grid, or storing the generated power for future use.

### FIELD OF THE INVENTION

This invention relates generally to the field of power distribution and more specifically to the field of harnessing and distributing electrical power from alternative power sources.

### BACKGROUND OF THE INVENTION

In the age of carbon emission concerns, identifying and efficiently delivering environmentally friendly sources of energy has become an important goal for both the government and the private sector. Environmentally friendly sources of electrical energy, or “green” energy as it is commonly called, include wind, solar, and hydroelectric energy sources that are typically associated with reduced pollution and lower carbon emission values.

In an ongoing effort to bring down the cost of environmentally friendly energy delivery, additional sources of energy need to be identified. However, cost-effective delivery of green energy is impeded in part by the relative scarcity of efficient means for distributing any locally generated green energy beyond the perimeter of the local environment.

### BRIEF SUMMARY OF THE INVENTION

Health equipment facilities, such as health clubs or physical rehabilitation centers, include various types of fitness equipment that serves to physically exercise the user. To harness the power generated by the fitness machines as a result of work expanded by human operators, the health equipment facility includes an On-Site Energy Generation, Storage and Distribution (GSD) module that serves as a medium between the local facility power distribution system and an external power grid. In general, the GSD module includes hardware, firmware and/or software for converting the mechanical energy generated by one or more fitness machines to electrical power, as well as computer executable instructions for allocating the electrical power between the local distribution system and an external power grid, or storing the generated power for future use.

In one aspect of the invention, a system is provided for harnessing and distributing electrical power from a fitness machine located in a building and operated by a human or animal operator, the system comprising (a) an electrical power generator coupled to the fitness machine for generating electrical power in response to an interaction of the operator with the fitness machine, (b) an energy storage device capable of storing at least some of the generated electrical power, and (c) a power controller adapted for accepting input of generated electrical power from the power generator, the power controller distributing the generated electrical power among one or more of the energy storage device, a building power distribution system, and a power grid external to the building, wherein the power grid supplies power to the building power distribution system.

In another aspect of the invention, a method is provided for harnessing and distributing electrical power from a fitness machine located in a building and operated by a human or animal operator, the method comprising (a) generating electrical power in response to an interaction of the operator with the fitness machine, (b) receiving an input of the generated electrical power, (c) assessing power consumption requirements for the building at a particular point in time, and (d) based on the assessment, distributing the generated electrical power among one or more of an energy storage device, a building power distribution system, and a power grid external to the building, wherein the power grid supplies power to the building power distribution system.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a schematic diagram of a system environment for generating and distributing electrical power from human-powered fitness equipment, in accordance with an embodiment of the invention;

FIG. 2 is a schematic diagram of the On-Site Energy Generation, Storage and Distribution (GSD) module of FIG. 1, in accordance with an embodiment of the invention; and

FIG. 3 is a flow chart of a method for harnessing and distributing electrical energy generated by fitness and exercise equipment, in accordance with an embodiment of the invention.

### DETAILED DESCRIPTION OF THE INVENTION

The following examples further illustrate the invention but, of course, should not be construed as in any way limiting its scope.

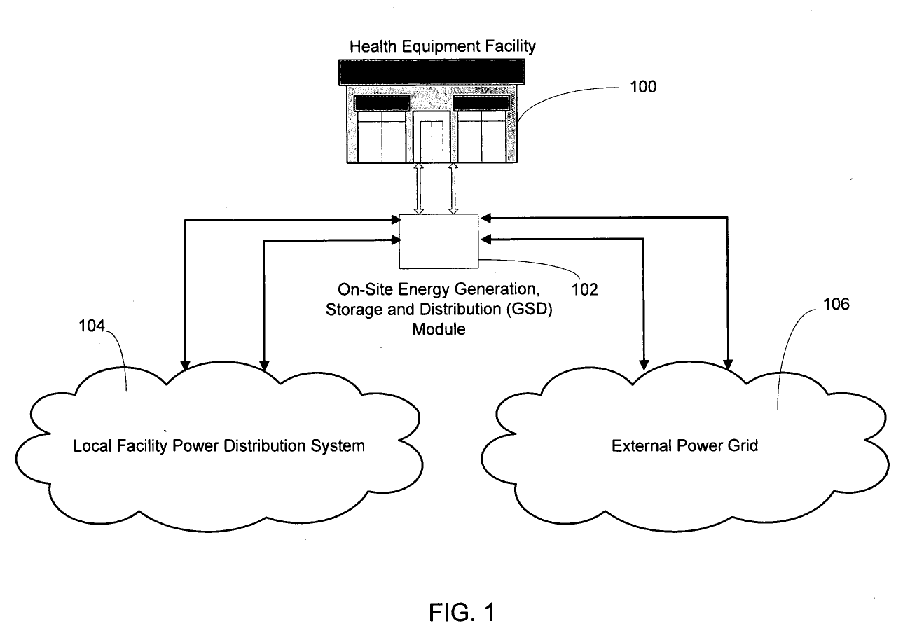

Turning to FIG. 1, an embodiment of a system environment for generating and distributing electrical power from human-powered fitness equipment is shown. To harness the power generated by one or more fitness machines as a result of work expanded by human operators, the health equipment facility 100 includes an On-Site Energy Generation, Storage and Distribution (GSD) module 102 that serves as a medium between the local facility power distribution system 104, which distributes delivered power within the facility 100, and an external power grid 106, which initially delivers power to the facility 100. In general, the GSD module 102 includes hardware, firmware and/or software for converting the mechanical energy generated by one or more fitness machines to electrical power, as well as computer executable instructions for allocating the electrical power between the local distribution system 104 and external power grid 106 or storing the generated power for future use. Due to the additional power capacity generated by the GSD module 102, the health equipment facility 100 increases its power efficiency by reducing the overall reliance on the external power grid 106. Similarly, the external power grid 106 gains additional power capacity by receiving input of extra electrical power available at the GSD 102. The power grid operator, therefore also gains an opportunity to increase revenues from redistributing the extra power to other sources. In embodiments, the health equipment facility 100 is a health club facility, a physical rehabilitation facility or another facility or building having fitness or exercise equipment that accepts human or animal input for expanding physical force upon interaction therewith.

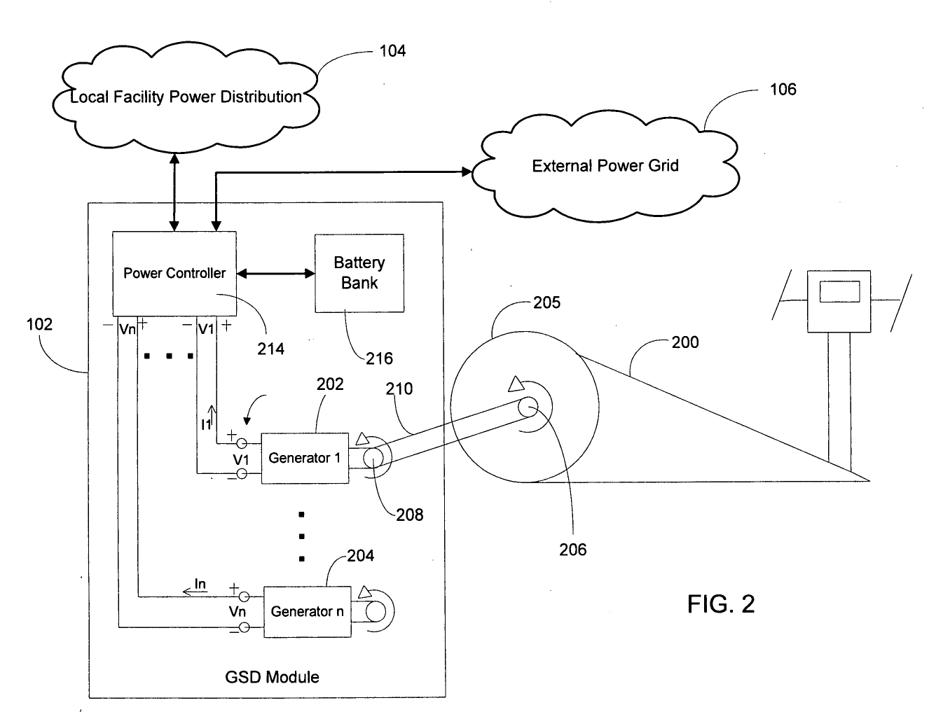

Turning to FIG. 2, an embodiment of the On-Site Energy Generation, Storage and Distribution module 102 is shown in more detail. In order to harness the mechanical energy generated by one or more fitness machines 200, the GSD module 102 includes one or more electrical power generators 202, 204 that interact with the fitness machines 200. For instance, when operation of the fitness machine 200 results in rotation of the pulley 206, the generator 202 harnesses the resulting rotational energy via pulley 208 coupled to the fitness machine pulley 206 via a belt 210. Optionally, the belt 210 is coupled directly to the wheel 205 of the fitness equipment 200. In embodiments, the fitness equipment 200 comprises an elliptical machine, a stationary bicycle, an unpowered treadmill machine, or any exercise machine capable of generating rotational motion in one or more directions due to human or animal interaction. Alternatively, the fitness equipment 200 comprises the type of exercise equipment that accepts a down force impact from an operator (e.g., a stair stepper or a jumping mat) and is coupled to one or more piezoelectric power generators that interface with the power controller 214 in the manner described below. Those skilled in the art will understand, however, that a number of alternative arrangements are possible in order to interface electrical generators to various types of fitness equipment. In a preferred embodiment, the generator 202 comprises a permanent magnet DC motor that generates a DC voltage V1 across the terminals 212 (and results in current i1) in response to the rotational movement of the pulley 208. The voltage V1 (and corresponding current i1) induced across the terminals 212 increases with an increase in the rate of rotation of the pulley 208 (in rotations per minute, RPM). The rate of rotation in RPM needed to generate a given amount of voltage across the terminals 212 depends, in part, upon the voltage rating of the permanent magnet motor 202. In other words, a motor with higher voltage rating requires a slower rate of rotation of the pulley 208, and correspondingly less effort from a human or animal powering the fitness equipment 200, to produce a given amount of voltage. Preferably, a single generator 202 interacts with a single fitness machine 200. Alternatively, a particular generator 202 is mechanically coupled to multiple fitness machines, such as via a pulley and gear system.

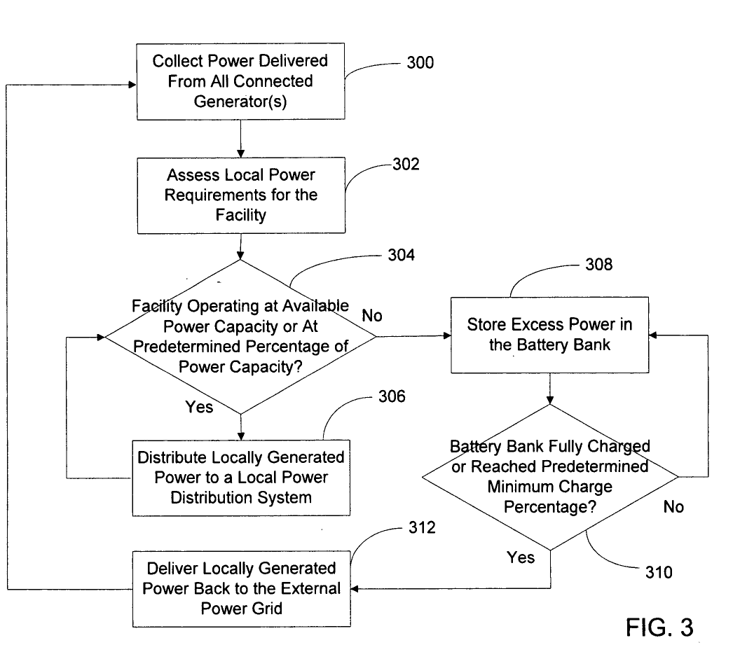

The power controller 214 receives input from one or more generators 202, 204 for the purpose of storing the generated electrical power in a battery bank 216 and/or distributing the generated power among local facility power distribution system 104 and the external power grid 106. In embodiments, the battery bank 216 comprises a lead acid battery bank, a lithium ion battery bank, and a lithium polymer battery bank. Preferably, the power controller 214 prioritizes delivery of available generated power by first satisfying the power requirements of the local facility power distribution system to power the health equipment facility 100 and then allocating at least a portion of available generated power for redistribution to the external power grid 106. In an alternative embodiment, each generator 202, 204 includes a controller responsible for first directly powering the associated fitness machine and providing any excess generated power to the power controller 214 for further distribution and/or storage. When multiple generators are used, the power controller 214 collects generated voltage V1 through Vn and makes the total generated power available for local and external use. In one embodiment, the power controller 214 includes one or more AC power inverters for distributing AC power. Depending on the power ratings of the local facility power distribution system (e.g., the maximum current rating of the wiring for the facility 100), the power interface of the external power grid 106 (e.g., rating of a nearby step-down transformer), and the input power rating of battery bank 216, the power controller 214 may further include one or more internal transformers for providing the corresponding rated power interfaces. As discussed in more detail with respect to FIG. 3 below, the power controller 214 manages the generated power capacity by preferably first satisfying the local power needs of the health equipment facility 100, and then storing a predetermined amount of generated power in the battery bank 216 and/or redistributing at least some available generated power back to the external power grid 106. In an embodiment, the power controller 214 includes a user interface for accepting user input with respect to power allocation priorities and corresponding threshold levels. Alternatively or in addition, the power controller 214 accepts configuration input from an external computer device.

Turning to FIG. 3, an embodiment of a method for harnessing electrical energy generated by fitness and exercise equipment is shown. In steps 300-302, the power controller 214 collects electrical power (i.e., voltage and current) generated by one or more connected generators 202, 204 and assesses the present power requirements of the health equipment facility 100. For instance, the power controller 214 evaluates the overall load imposed by the local facility power distribution system 104 on the external power grid 106 with respect to the power capacity allocated to the facility 100 by the operator of the external power grid 106. In steps 304-306, if the facility 100 presently requires either a full power capacity allocated to it by the external power grid operator or is operating at a predetermined threshold percentage (e.g., 70 percent or above) of available power capacity, the power controller 214 directs incoming and/or stored electrical energy to the local facility power distribution system 104 for satisfying local power needs. If, however, the facility 100 is operating below the threshold capacity (or below full capacity) of step 304, the power controller 214 stores the available excess power in the battery bank 216 for subsequent use, step 308. Preferably, the threshold of power capacity (whether a percentage or an absolute value) that the power controller 214 uses to determine the routing of the generated and/or stored power is user-selectable via either a local or remote user interface. In steps 310-312, when the battery bank 216 is fully charged or reaches a predetermined (e.g., user-definable) charge threshold, the power controller 214 delivers the locally generated electrical power back to the external power grid 106.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for harnessing and distributing electrical power from a fitness machine located in a building and operated by a human or animal operator, the system comprising:
an electrical power generator coupled to the fitness machine for generating electrical power in response to an interaction of the operator with the fitness machine;
an energy storage device capable of storing at least some of the generated electrical power; and
a power controller adapted for accepting input of generated electrical power from the power generator, the power controller distributing the generated electrical power among one or more of the energy storage device, a building power distribution system, and a power grid external to the building, wherein the power grid supplies power to the building power distribution system.

2. The system of claim 1 wherein the electric power generator comprises a permanent magnet motor.

3. The system of claim 1 wherein the electric power generator is a piezoelectric generator.

4. The system of claim 1 wherein the fitness machine is one of an elliptical machine, a stationary bicycle, a stair machine, and a jumping mat.

5. The system of claim 1 wherein the energy storage device comprises a battery bank.

6. The system of claim 5 wherein the battery bank is one of a lead acid battery bank, a lithium ion battery bank, and a lithium polymer battery bank.

7. The system of claim 1 wherein the power controller is adapted to assess power consumption requirement for the building at a particular point in time.

8. The system of claim 7 wherein the power controller distributes the generated electrical power based on the assessment.

9. The system of claim 8 wherein the power controller distributes the generated power to the building power distribution system when the assessment indicates that the building is operating at one of an available power capacity limit supplied by the power grid external to the building and at a predetermined percentage of the available power capacity limit.

10. The system of claim 8 wherein the power controller stores excess generated power in the energy storage device when the assessment indicates that the building is operating below one of an available power capacity limit supplied by the power grid external to the building and a predetermined percentage of the available power capacity limit supplied by the power grid external to the building.

11. The system of claim 10 wherein the power controller returns at least some generated electrical power to the power grid external to the building when the energy storage device is substantially charged and the building is operating below one of the available power capacity and a predetermined percentage of the available power capacity limit supplied by the power grid external to the building.

12. A method for harnessing and distributing electrical power from a fitness machine located in a building and operated by a human or animal operator, the method comprising:
generating electrical power in response to an interaction of the operator with the fitness machine;
receiving an input of the generated electrical power;
assessing power consumption requirements for the building at a particular point in time; and
based on the assessment, distributing the generated electrical power among one or more of an energy storage device, a building power distribution system, and a power grid external to the building, wherein the power grid supplies power to the building power distribution system.

13. The method of claim 12 further comprising generating the electrical power via a permanent magnet motor.

14. The method of claim 12 further comprising generating the electrical power via a piezoelectric generator.

15. The method of claim 12 wherein the fitness machine is one of an elliptical machine, a stationary bicycle, a stair machine, and a jumping mat.

16. The method of claim 12 wherein the energy storage device comprises a battery bank.

17. The method of claim 16 wherein the battery bank is one of a lead acid battery bank, a lithium ion battery bank, and a lithium polymer battery bank.

18. The method of claim 12 further comprising distributing the generated power to the building power distribution system when the assessment indicates that the building is operating at one of an available power capacity limit supplied by the power grid external to the building and at a predetermined percentage of the available power capacity limit.

19. The method of claim 12 further comprising storing excess generated power in the energy storage device when the assessment indicates that the building is operating below one of an available power capacity limit supplied by the power grid external to the building and a predetermined percentage of the available power capacity limit supplied by the power grid external to the building.

20. The method of claim 19 further comprising returning at least some generated electrical power to the power grid external to the building when the energy storage device is substantially charged and the building is operating below one of the available power capacity and a predetermined percentage of the available power capacity limit supplied by the power grid external to the building.
